(19) United States
(12) Patent Application Publication
(10) Pub. No.: US 2012/0048061 A1
(43) Pub. Date: Mar. 1, 2012

(54) CLAMPING MEMBER, CLIPLESS PEDAL USING THE SAME, AND MANUFACTURING METHOD THEREOF

(75) Inventor: Wen-Hwa Lin, Taichung City (TW)

(73) Assignee: VP COMPONENTS CO., LTD., Taichung Hsien (TW)

(21) Appl. No.: 12/967,405

(22) Filed: Dec. 14, 2010

(30) Foreign Application Priority Data
Sep. 1, 2010 (TW) 099129553

(51) Int. Cl. B62M 3/08; B29C 45/14

(52) U.S. Cl. 74/594.6; 264/259

(57) ABSTRACT

A manufacturing method for making a clamping member of a clipless pedal includes steps of: providing a mold for the clamping member, wherein the mold is formed with a mold cavity; placing a spring-driven adjusting bar into the mold such that at least one part of the spring-driven adjusting bar is positioned in the mold cavity; injecting a material for the clamping member into the mold cavity so that the material is molded in the mold cavity to fixedly incorporate the spring-driven adjusting bar; and removing the molded clamping member from the mold to present the clamping member with the spring-driven adjusting bar to be used in a clipless pedal.

### BACKGROUND OF THE INVENTION

1. Technical Field

The present invention relates to clipless pedals, and more particularly, to a manufacturing method of a clamping member that fixedly incorporates a spring-driven adjusting bar for simplifying the configuration and assembling process of a clipless pedal using the clamping member. The present invention also relates to the clamping member made using the manufacturing method and a clipless pedal using such clamping member.

2. Description of Related Art

A bicycle clipless pedal is designed to removably engage with a shoe cleat of a bicycle shoe for thereby preventing a foot of a cyclist from accidentally coming off the pedal. As compared with traditional simple pedals, clipless pedals are proven helpful to cyclists in saving pedaling force, sustaining acceleration, and ensuring riding safety, so they are extensively used in various bicycles, such as cross-country bikes, freerider bikes, and road racing bikes.

As to existing clipless pedals, for example, U.S. Pat. No. 6,708,584 has disclosed a bicycle pedal assembly, which comprises a pedal shaft, a pedal body rotatably coupled to the pedal shaft, and a front clamping member as well as a rear clamping member connected to a first end and a second end of the pedal body, respectively. The above-cited US patent also provides a shoe cleat configured to engage with the pedal assembly. The cleat has a front cleat engagement surface and a rear cleat engagement surface for coupling with the front clamping member and the rear clamping member, respectively. A pin is provided at the rear part of the pedal body and a pair of torsion springs is mounted on the pin. The torsion springs each have one end connected to the rear clamping member and the other end coupled to an adjustment mechanism provided on the rear clamping member. The adjustment mechanism may press or release the torsion springs to change a prestressing force applied to the torsion springs, so as to adjust tightness of the engagement between the clamping members and the cleat.

However, the above-mentioned known clipless pedal is disadvantageously composed of a large number of components. Particularly, the adjustment mechanism and the torsion springs are constructed from various small parts, which require complicated assembling steps that are unfavorable to mass production. In addition, for carrying the adjustment mechanism, the rear clamping member has to be designed with structural and mechanical complexity, which is also adverse to mass production. During the injection-molding process for making the rear clamping member, the complexity thereof unavoidably requires precise and complicated mold, which means increased manufacturing costs and difficulties in removing the product from the mold.

### SUMMARY OF THE INVENTION

It is thus found that the existing clamping member for a clipless pedal has the defects relates to its numerous small parts, complicated assembling process and difficult production. In view of these defects, the present invention provides a novel clamping member, a clipless pedal using such clamping member and a manufacturing method thereof.

The present invention discloses a manufacturing method for a clamping member of a clipless pedal, which comprises steps of:

providing a mold for the clamping member, wherein the mold is formed therein with a mold cavity;

placing a spring-driven adjusting bar into the mold such that at least a part of the spring-driven adjusting bar is positioned in the mold cavity;

injecting a material for the clamping member into the mold cavity so that the material is molded in the mold cavity to fixedly incorporate the spring-driven adjusting bar; and

removing the molded clamping member from the mold to present the clamping member with the spring-driven adjusting bar to be used in the clipless pedal.

One objective of the present invention is to provide the manufacturing method for simplifying the assembling and manufacturing process of the clamping member and the clipless pedal using the clamping member. Therein, the spring-driven adjusting bar is at least partially positioned in the mold cavity of the mold, so that in the course of the injection-molding process for making the clamping member, the clamping member fixedly incorporates the spring-driven adjusting bar as a whole piece, thereby simplifying the assembling process of the clamping member and reducing the structural complexity of the clamping member, thus being suitable for molding with lowered manufacturing costs.

Another objective of the present invention is to provide a clamping member for a clipless pedal, wherein the clamping member is made using the foregoing manufacturing method and comprises:

a main body having a pressing end and a pivotal end; and

the spring-driven adjusting bar attached to the pivotal end, and wherein the spring-driven adjusting bar has an embedded portion that is embedded in the main body.

A third objective of the present invention is to provide a clipless pedal using a clamping member that is made using the foregoing manufacturing method, wherein the clipless pedal comprises:

a pedal shaft;

a pedal body that is combined with the pedal shaft and rotatable against the pedal shaft, the pedal body having two ends formed as a retaining end and a clamping end, respectively, wherein the clamping end allows the clamping member to be pivotally connected thereto with a pivot portion;

a torsion spring mounted around the pivot portion, the torsion spring having two ends fixed to the pedal body, so as to apply a resilient pushing force to the clamping member; and

an adjustment mechanism provided on the spring-driven adjusting bar for adjusting a prestressing force of the torsion spring.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a flowchart of a manufacturing method for a clamping member of a clipless pedal according to the present invention;

FIGS. 2 to 4 illustrate the manufacturing method of the present invention;

FIG. 5 is an exploded view of a clipless pedal according to the present invention;

FIG. 6 is an assembled view of the clipless pedal according to the present invention;

FIG. 7 is a perspective view of a spring-driven adjusting bar according to the present invention; and

FIGS. 8 to 9 illustrate operation of the clipless pedal according to the present invention.

### DETAILED DESCRIPTION OF THE INVENTION

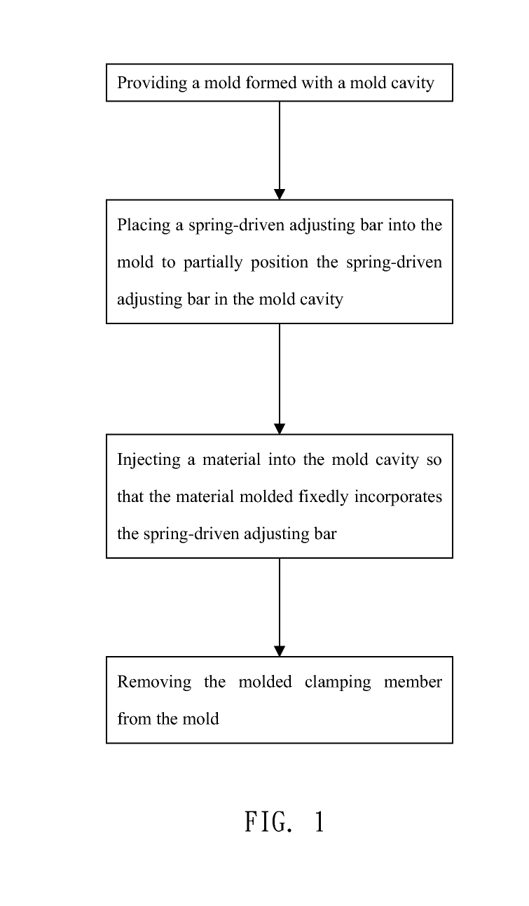

Referring to FIG. 1, according to the present invention, a manufacturing method for a clamping member of a clipless pedal comprises the following steps.

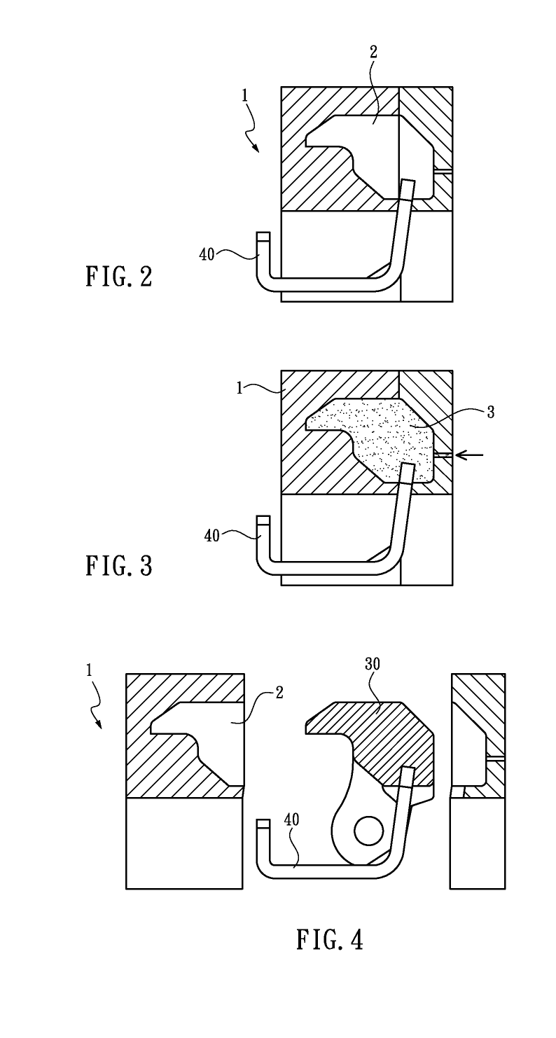

As shown in FIG. 2, a mold 1 for the clamping member is provided. The mold 1 may be composed of a plurality of detachable members so as to facilitate mold opening for taking out the molded product. Therein, the mold 1 includes a mold cavity 2.

Then a spring-driven adjusting bar 40 is placed into the mold 1 such that at least a part thereof is positioned in the mold cavity 2. The spring-driven adjusting bar 40 may be completely received in the mold 1, or may have a part thereof projecting outside from the mold 1, according to the required final product and/or subsequent process.

Afterward, as shown in FIG. 3, a material 3 for the clamping member is injected into the mold cavity 2 through, for example, an injection-molding process. The material 3 is molded in the mold cavity 2 and thereby fixedly incorporates the spring-driven adjusting bar 40.

At last, as shown in FIG. 4, the members of the mold 1 are disassembled to allow the molded clamping member 30 to be removed from the mold 1, so as to present the clamping member 30 with the spring-driven adjusting bar 40.

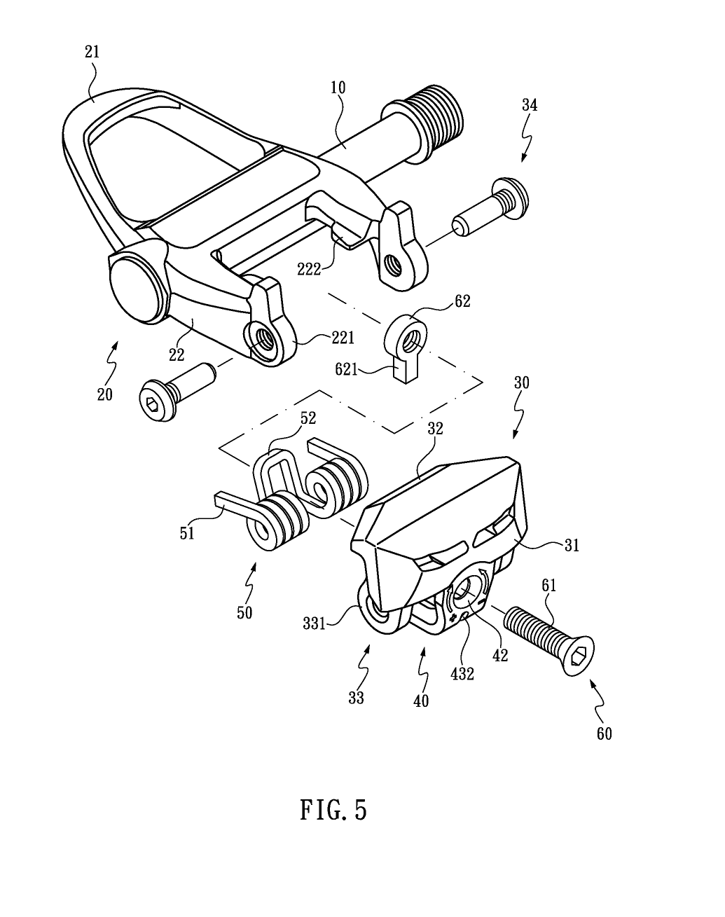

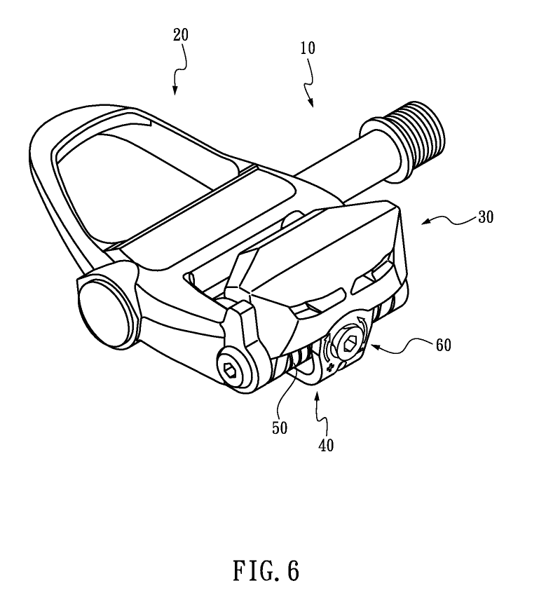

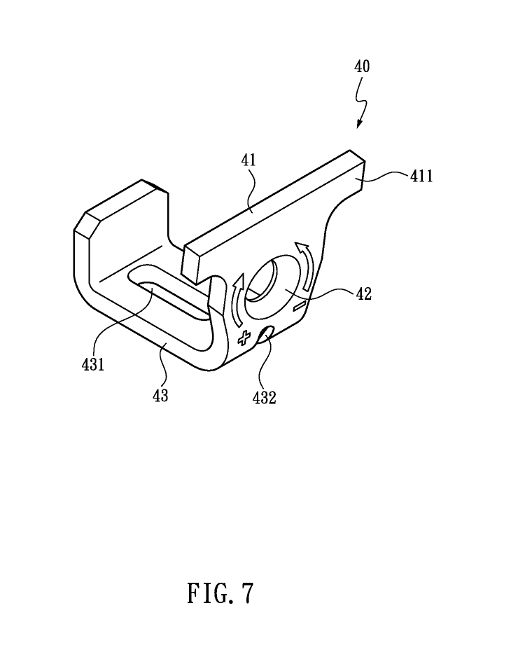

Referring to FIG. 5 through FIG. 7, a clipless pedal using a clamping member that is made using the foregoing manufacturing method comprises the following components:

a pedal shaft 10;

a pedal body 20 that is combined with the pedal shaft 10 and rotatable against the pedal shaft 10, wherein the pedal body 20 has two ends formed as a retaining end 21 and a clamping end 22, respectively, in which the retaining end 21 is an immovable frame and the clamping end 22 includes connecting portions 221 extending outward along two opposite laterals of the pedal body 20 as well as retaining nodes 222 extending inward; and

the clamping member 30 made using the manufacturing method described above.

The clamping member 30 comprises:

a main body 31 having a pressing end 32 and a pivotal end 33, wherein the pivotal end 33 has a pair of connecting plates 331 for receiving a pivot portion 34, such as a pair of bolts, so to be pivotally combined with the connecting portions 221;

the spring-driven adjusting bar 40 located at the pivotal end 33 of the main body 31, wherein the spring-driven adjusting bar 40 has an embedded portion 41 that is embedded in the main body 31, and the embedded portion 41 has a pair of wing portions 411 extending outward from two opposite laterals thereof;

a torsion spring 50 that is mounted around the pivot portion 34 and has two ends formed with pins 51 that is fixed to the retaining nodes 222 of the pedal body 20, wherein the torsion spring 50 has its middle portion formed with a pressing portion 52; and

an adjustment mechanism 60 provided on the spring-driven adjusting bar 40 for adjusting a prestressing force of the torsion spring 50, wherein the spring-driven adjusting bar 40 is formed with a threaded hole 42 for receiving an adjusting screw 61, and the adjusting screw 61 is coupled to an adjusting piece 62 through the pressing portion 52 of the torsion spring 50 with the pressing portion 52 sandwiched therebetween and pressing against the adjusting piece 62, so as to apply a resilient pushing force to the clamping member 30.

In addition, the spring-driven adjusting bar 40 has an adjusting segment 43 extending coaxially to the adjusting screw 61 away from the embedded portion 41 and formed with a bended portion. The adjusting segment 43 is provided with a slot 431, and the adjusting piece 62 has a protrusion 621 configured to be slidably received in the slot 431. The spring-driven adjusting bar 40 has a reinforcing rib 432 formed at the bended portion of the adjusting segment 43. The reinforcing rib 432 is recessed from the spring-driven adjusting bar 40.

With the aforementioned configuration, the clipless pedal and clamping member of the present invention are enabled to operate in the manner explained below.

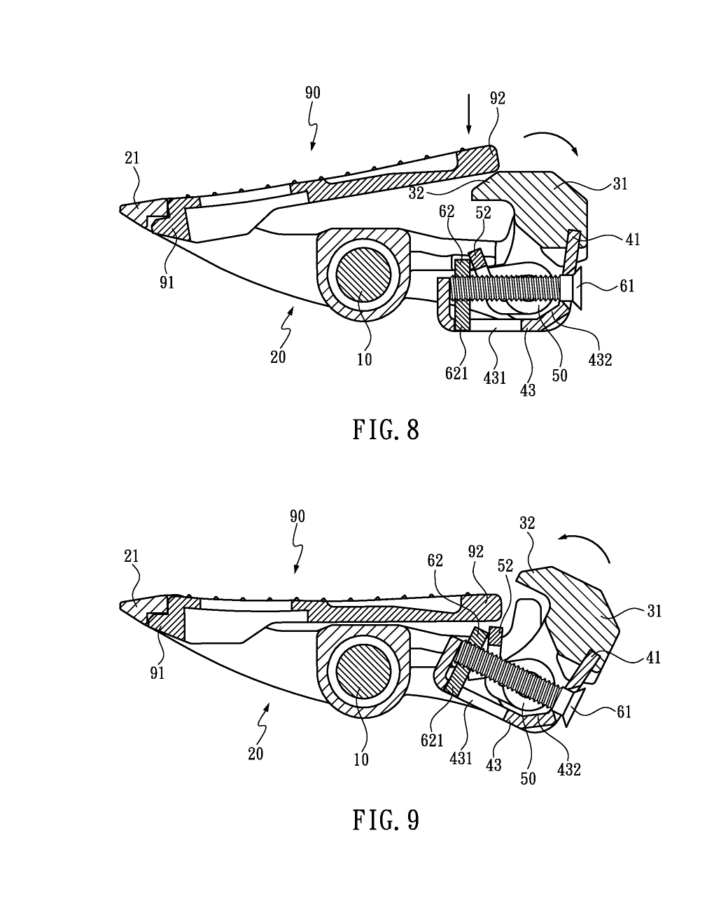

As shown in FIG. 8, the clipless pedal of the present invention is configured to mate with a shoe cleat 90, which has a front combining portion 91 and a rear combining portion 92. In use, a user may place a bicycle shoe on the clipless pedal to make the front combining portion 91 of the shoe cleat 90 combined with the retaining end 21, and then step on the rear combining portion 92. At this time, since the pressing end 32 has is upper face formed as an incline, the clamping member 30 is forced to rotate outward, thereby increasing the distance between the retaining end 21 and the pressing end 32. Thus, as shown in FIG. 9, the rear combining portion 92 of the cleat can be smoothly put into the clamping member 30. Afterward, in virtue of the resilient pushing force provided by the torsion spring 50, the clamping member 30 returns to make the retaining end 21 and the pressing end 32 engage with the front combining portion 91 and the rear combining portion 92 of the cleat 90, respectively, so as to prevent the user's feet from accidentally coming off the pedal when he/she rides a bike, thereby protecting the user from accidents such as muscle strains.

Moreover, since the pressing portion 52 of the torsion spring 50 presses against the adjusting piece 62, when it is desired to adjust the tightness between the cleat 90 and the clipless pedal, the user can easily screw the adjusting screw 61 to drive the adjusting piece 62 to shift along the slot 431, so as to change the prestressing force the adjusting piece 62 applies to the pressing portion 52 of the torsion spring 50, and in turn adjust the tightness between the cleat 90 and the clipless pedal.

In the present invention, the spring-driven adjusting bar 40 is at least partially positioned in the mold cavity 2 of the mold 1, so that in the course of the injection-molding process for making the clamping member 30, the clamping member 30 fixedly incorporates the spring-driven adjusting bar 40 as a whole piece, thereby simplifying the assembling process of the clamping member 30 and reducing the structural complexity of the clamping member 30, thus being suitable for molding with lowered manufacturing costs.

Furthermore, the wing portions 411 extending outward from the two laterals of the embedded portion 41 of the spring-driven adjusting bar 40 help to ensure firm combination between the main body 31 and the spring-driven adjusting bar 40 embedded therein, and eliminate looseness over long term of use. Moreover, the spring-driven adjusting bar 40 may be made of metal with the reinforcing rib 432 further preventing the spring-driven adjusting bar 40 from deformation under external force, so as to substantially increase the mechanical strength, wear resistance and reliability of the product.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A manufacturing method for a clamping member of a clipless pedal, comprising steps of:
providing a mold for the clamping member, wherein the mold is formed therein with a mold cavity;
placing a spring-driven adjusting bar into the mold such that at least a part of the spring-driven adjusting bar is positioned in the mold cavity;
injecting a material for the clamping member into the mold cavity so that the material is molded in the mold cavity to fixedly incorporate the spring-driven adjusting bar; and
removing the molded clamping member from the mold to present the clamping member with the spring-driven adjusting bar to be used in the clipless pedal.

2. A clamping member of a clipless pedal made using the manufacturing method of claim 1, comprising:
a main body having a pressing end and a pivotal end; and
the spring-driven adjusting bar attached to the pivotal end, wherein the spring-driven adjusting bar has an embedded portion that is embedded in the main body.

3. The clamping member of claim 2, wherein the embedded portion has a pair of wing portions extending outward from two opposite laterals of the embedded portion.

4. The clamping member of claim 2, wherein the pivotal end of the main body has a pair of connecting plates for receiving a pivot portion, so as to be pivotally combined with a pedal body, and a torsion spring is mounted around the pivot portion for applying a resilient pushing force to the pressing end.

5. The clamping member of claim 4, wherein the spring-driven adjusting bar is formed with a threaded hole for receiving an adjusting screw and the adjusting screw is coupled with an adjusting piece.

6. The clamping member of claim 5, wherein the spring-driven adjusting bar has an adjusting segment extending coaxially to the adjusting screw away from the embedded portion and formed with a bended portion, the adjusting segment being provided with a slot, and the adjusting piece having a protrusion configured to be slidably received in the slot.

7. The clamping member of claim 6, wherein the torsion spring has a pressing portion corresponding to the adjusting screw, and when the adjusting screw passes through the pressing portion and is screwed with threaded hole, the pressing portion presses against the adjusting piece.

8. The clamping member of claim 7, wherein the torsion spring has at least one pin that is fixed to the pedal body.

9. The clamping member of claim 6, wherein the spring-driven adjusting bar has a reinforcing rib formed at the bended portion of the adjusting segment.

10. A clipless pedal having a clamping member that is made using the manufacturing method of claim 1, comprising:
a pedal shaft;
a pedal body that is combined with the pedal shaft and rotatable against the pedal shaft, the pedal body having two ends formed as a retaining end and a clamping end, respectively, wherein the clamping end allows the clamping member to be pivotally connected thereto with a pivot portion;
a torsion spring mounted around the pivot portion, the torsion spring having two ends fixed to the pedal body, so as to apply a resilient pushing force to the clamping member; and
an adjustment mechanism provided on the spring-driven adjusting bar for adjusting a prestressing force of the torsion spring.
